(19) United States
(12) Patent Application Publication
(10) Pub. No.: US 2023/0015479 A1
(43) Pub. Date: Jan. 19, 2023

(54) METHOD AND APPARATUS FOR ELECTRONIC COMMERCE OF VEHICLES

(71) Applicant: 12771888 Canada Inc., Mississauga (CA)

(72) Inventor: Ryan P. DAVIDSON, Miami, FL (US)

(21) Appl. No.: 17/812,291

(22) Filed: Jul. 13, 2022

Related U.S. Application Data
(60) Provisional application No. 63/203,223, filed on Jul. 13, 2021.

(51) Int. Cl. G06Q 30/06

(52) U.S. Cl. CPC G06Q 30/0625

(57) ABSTRACT

Disclosed is a method of electronic commerce of vehicles. The method involves a server sending, responsive to search parameters, search results including identifying information of one or more matching vehicles. Available vehicles are conditionally included in the search results based on whether the available vehicles match the search parameters and each additional condition is met. In accordance with an embodiment of the disclosure, the additional condition includes a condition that, for each available vehicle in which its source market is different from a destination market of a prospective purchaser, a list price plus additional charges for exporting the available vehicle from the source market to the destination market is less than the wholesale value in the destination market. Thus, available vehicles that are too expensive and thus not practical for sale in a destination market can be omitted, thereby improving the electronic commerce of vehicles.

### RELATED APPLICATION

This patent application claims priority to U.S. provisional patent application No. 63/203,223 filed Jul. 13, 2021, the entire content of which is incorporated by reference herein.

### FIELD OF THE DISCLOSURE

This disclosure relates to computing systems, and more particularly to computing systems for electronic commerce of vehicles.

### BACKGROUND

A difference in wholesale price of a vehicle across markets, arbitrage of currency etc., are already being used by many businesses to connect automobile dealers from one market to another. A simple example is the trade of old Japanese cars into some African markets.

However, such existing approaches can be cumbersome and inadequate. It is desirable to improve upon the existing approaches while enabling electronic commerce of vehicles across global markets.

### SUMMARY OF THE DISCLOSURE

Disclosed is a method for execution by a server of a communications system having a network. The method involves the server receiving, over the network, vehicle listings concerning available vehicles for purchase across global markets. The vehicle listings include, for each available vehicle, identifying information of the available vehicle and a list price of the available vehicle in a source market. The method also involves the server receiving, over the network, for each available vehicle and for each market of a plurality of markets, a wholesale value of the available vehicle in the market.

The method also involves the server receiving, over the network, a message having search parameters for available vehicles in a destination market. The method also involves the server sending, over the network, search results including the identifying information of one or more matching vehicles of the available vehicles. The available vehicles are conditionally included in the search results based on whether the available vehicles match the search parameters and each additional condition of a set of at least one additional condition is met.

In accordance with an embodiment of the disclosure, the set of at least one additional condition includes, for each available vehicle in which the source market is different from the destination market, the list price plus additional charges for exporting the available vehicle from the source market to the destination market being less than the wholesale value in the destination market. For at least one of the matching vehicle(s), the source market of the matching vehicle is different from the destination market. However, available vehicles that are too expensive and thus not practical for sale in a destination market can be omitted.

In some implementations, the set of at least one additional condition also includes, for each available vehicle, the available vehicle being eligible for sale in the destination market according to law and/or regulation. Thus, available vehicles that are not permitted for sale in a destination market can be omitted.

Also disclosed is a non-transitory computer readable medium having recorded thereon statements and instructions that, when executed by a processor of a server, configure the processor to implement a method as summarized above.

Also disclosed is a server having a network adapter, and vehicle trade circuitry coupled to the network adapter and configured to implement a method as summarized above.

Also disclosed is a method for execution by a server of a communications system having a network. The method involves the server receiving, over the network, a vehicle listing concerning an available vehicle. The vehicle listing include identifying information for the available vehicle and a list price for the available vehicle in a source market. The method also involves the server receiving, over the network, a wholesale value for the available vehicle in a destination market, such that the destination market and the source market are different markets.

The method also involves the server receiving, over the network, a message concerning potential purchase of the available vehicle in the destination market. The method also involves the server sending, over the network, the identifying information for the available vehicle only if each condition of a set of at least one condition is met.

In accordance with an embodiment of the disclosure, the set of at least one condition includes the list price plus additional charges for exporting the available vehicle from the source market to the destination market being less than the wholesale value in the destination market. Thus, if the available vehicle is too expensive and thus not practical for sale in the destination market, then the identifying information for the available vehicle is not provided.

In some implementations, the set of at least one condition also includes the available vehicle being eligible for sale in the destination market according to law and/or regulation. Thus, if the available vehicles is not permitted for sale in the destination market, then the identifying information for the available vehicle is not provided.

Also disclosed is a non-transitory computer readable medium having recorded thereon statements and instructions that, when executed by a processor of a server, configure the processor to implement a method as summarized above.

Also disclosed is a server having a network adapter, and vehicle trade circuitry coupled to the network adapter and configured to implement a method as summarized above.

Also disclosed is a method for execution by a server of a communications system having a network. The method includes the server receiving, over the network, vehicle listings concerning available vehicles for purchase across global markets. The vehicle listings include, for each available vehicle, identifying information of the available vehicle in a source market. The method also includes the server receiving, over the network, for each available vehicle and for each market of a plurality of markets, a wholesale value of the available vehicle in the market.

The method also includes the server receiving, over the network, a message having search parameters for available vehicles in a destination market. The method also includes the server sending, over the network, search results including the identifying information of one or more matching vehicles of the available vehicles. The available vehicles are conditionally included in the search results based on whether the available vehicles match the search parameters and each additional condition of a set of at least one additional condition is met.

In accordance with an embodiment of the disclosure, the set of at least one additional condition includes, for each available vehicle, the available vehicle being eligible for sale in the destination market according to law and/or regulation. For at least one of the matching vehicle(s), the source market of the matching vehicle is different from the destination market. Thus, available vehicles that are not permitted for sale in the destination market can be omitted.

Other aspects and features of the present disclosure will become apparent, to those ordinarily skilled in the art, upon review of the following description of the various embodiments of the disclosure.

### BRIEF DESCRIPTION OF THE DRAWINGS

Embodiments will now be described with reference to the attached drawings in which:

FIG. 1 is a block diagram of an example communication system having a server coupled to external information sources and client devices via a network;

FIG. 2 is a flowchart of a method of facilitating electronic commerce of vehicles across global markets;

FIG. 3 is a flowchart of a method of offering available vehicles depending on profitability;

FIG. 4 is a flowchart of a method of finding profitable vehicles; and

FIG. 5 is a flowchart of a method of enabling prospective buyers to find their desired vehicles from global markets.

### DETAILED DESCRIPTION OF EMBODIMENTS

It should be understood at the outset that although illustrative implementations of one or more embodiments of the present disclosure are provided below, the disclosed systems and/or methods may be implemented using any number of techniques. The disclosure should in no way be limited to the illustrative implementations, drawings, and techniques illustrated below, including the exemplary designs and implementations illustrated and described herein, but may be modified within the scope of the appended claims along with their full scope of equivalents.

### INTRODUCTION

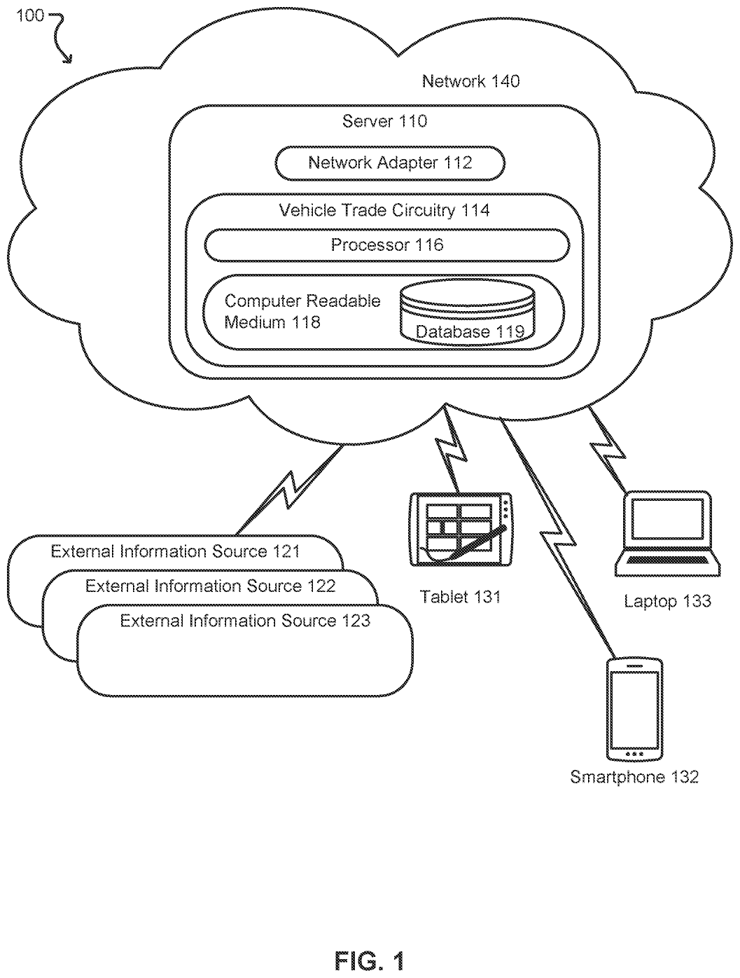

Referring first to FIG. 1, shown is a block diagram of an example communication system 100 having a server 110 coupled to external information sources 121-123 and client devices 131-133 via a network 140. The communication system 100 can have numerous other external information sources and client devices, although only a few are shown for simplicity. It is to be understood that the external information sources 121-123 and the client devices 131-133 are not all co-located in a single location or region as might be implied by FIG. 1, but rather are in disparate locations around the world, such that the communication system 100 spans across multiple markets (e.g. multiple countries).

The server 110 has a network adapter 112 for communicating with the external information sources 121-123 and the client devices 131-133 over the network 140, and vehicle trade circuitry 114 that implements functionality for the server 110 to facilitate electronic commerce of vehicles amongst buyers and sellers via the client devices 131-133 as described in further detail below.

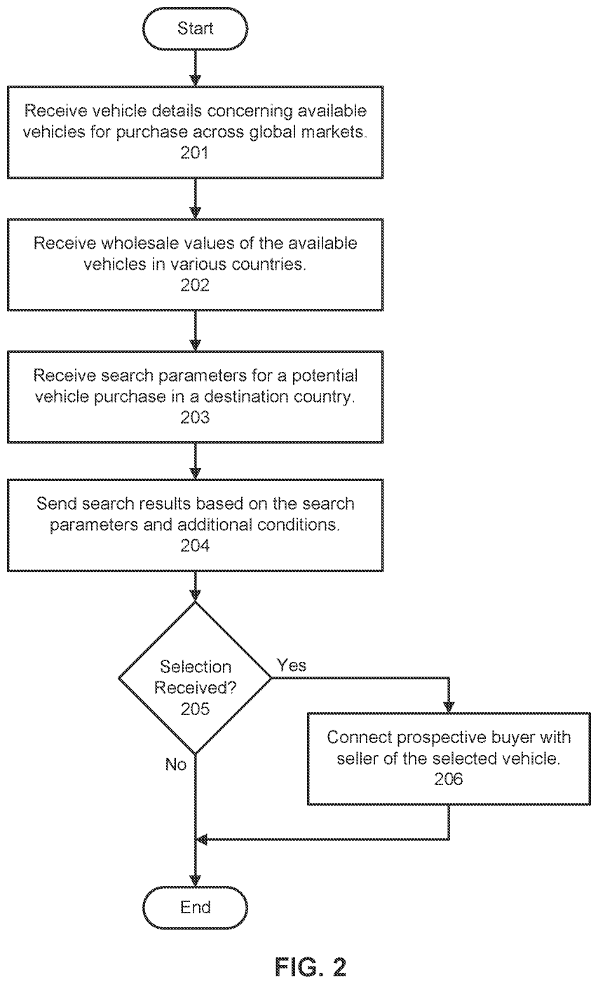

Operation of the vehicle trade circuitry 114 of the server 110 will be described below with reference to FIG. 2, which is a flowchart of a method of facilitating electronic commerce of vehicles across global markets. Although the method of FIG. 2 is described below with reference to the server 110 in the communication system 100 shown in FIG. 1, it is to be understood that the method of FIG. 2 is applicable to other communication systems. In general, the method of FIG. 2 is applicable to the server 110 in any appropriately configured system.

At step 201, the server 110 receives, over the network 140, vehicle listings concerning available vehicles for purchase across global markets. The vehicle listings include, for each available vehicle, identifying information of the available vehicle and a list price of the available vehicle in a source market (e.g. source country). The vehicle listings can be obtained from one or more of the external information sources 121-123. There are many possibilities. In some implementations, the server 110 integrates with retail websites, such that at least some of the vehicle listings are received via the retail websites. Example retail websites include Autotrader, Cargurus, Kijiji, etc. Additionally, or alternatively, the server 110 receives a list of vehicles in a sales dealership inventory, such that at least some of the vehicle listings are received via the list of vehicles in the sales dealership inventory. Additionally, or alternatively, the server 110 monitors inventory in the market, via API (Application Programming Interface) feeds, content aggregators, and/or web indexing, such that at least some of the vehicle listings concerning available vehicles are received via the monitoring. Other implementations are possible.

At step 202, the server 110 receives, over the network 140, for each available vehicle and for each market of a plurality of markets, a wholesale value of the available vehicle in the market. The wholesale values can be obtained from one or more of the external information sources 121-123. There are many possibilities. In some implementations, the server 110 integrates with wholesale websites, such that at least some of the wholesale values are received via the wholesale websites. Additionally, or alternatively, the server 110 classifies and/or groups individual inventory items across global market for aspects of similarity to obtain the wholesale values using (i) a VIN (Vehicle Identification Number) number, or details derived thereof, (ii) logic or rule-based processing, and/or (iii) clustering, classification, regression, or other mathematical methods that are trained from any type of data. Other implementations are possible.

At step 203, the server 110 receives, over the network 140, a message having search parameters for available vehicles in a destination market (e.g. destination country). The search parameters can be received from one of the client devices 131-133, for example a tablet 131 being used by a prospective purchaser. There are many possibilities. In some implementations, the server 110 receives the search parameters from the tablet 131 via a web form. Other implementations are possible.

At step 204, the server 110 sends, over the network 140, search results including the identifying information of one or more matching vehicles of the available vehicles. The search results can then be received by the tablet 131 so that the prospective purchaser can view the same. Notably, the available vehicles are conditionally included in the search results based on whether the available vehicles match the search parameters and each additional condition is met.

In accordance with an embodiment of the disclosure, the additional condition includes a condition that, for each available vehicle in which the source market is different from the destination market, the list price plus additional charges for exporting the available vehicle from the source market to the destination market being less than the wholesale value in the destination market. For at least one of the matching vehicle(s), the source market of the matching vehicle is different from the destination market. However, available vehicles that are too expensive and thus not practical for sale in a destination market can be omitted, thereby improving the electronic commerce of vehicles.

In some implementations, the server 110 monitors costs or fees, taxes, foreign exchange rates and/or cost of capital, and based on such monitoring, the server 110 determines a difference between (i) the list price plus the additional charges for exporting the available vehicle from the source market to the destination market and (ii) the wholesale value in the destination market. In some implementations, based on the monitoring, the server 110 incorporates a cushion amount, such that the list price plus the additional charges must be less than the wholesale value by that cushion amount. Such cushion amount can help to provide for price stability, such that calculations of profitability of a vehicle would not need to be continuously redone every hour or day even though some variables such as foreign exchange rates may change every minute or hour.

Additionally, or alternatively, the additional condition includes a condition that, for each available vehicle, the available vehicle is eligible for sale in the destination market according to law and/or regulation. Thus, available vehicles that are not permitted for sale in a destination market can be omitted. In some implementations, to determining the law and/or regulation, the server 110 monitors admissibility and logistics regulation. Other implementations are possible.

In some implementations, the server 110 maintains a database 119 of the available vehicles, and generates the search results based on an internal search of the database using the search parameters. In some implementations, the server 110 generates the search results based on the internal search and an additional external search of available vehicles for purchase across global markets. The additional external search could be performed for example when and if the internal search is not successful in finding many or any available vehicles.

The prospective purchaser can review the search results, which may be limited to only available vehicles that match the search parameters and each additional condition described above. In some implementations, if at step 205 the server 110 receives, over the network 140, a message identifying a selected vehicle among the matching vehicle(s) for possible purchase, then at step 206 the server 110 connects the prospective buyer with a seller of the selected vehicle. There are many possibilities. In some implementations, the server 110 enables the prospective buyer to communicate directly with the seller via email, text, telephony, video conference, etc. Other implementations are possible. The seller could be using one of the one of the client devices 131-133, for example a smartphone 132. Thus, in the provided example, communication can be established between the tablet 131 and the smartphone 132 to enable the prospective buyer and the seller to communicate with each other.

In the above scenario, steps 205 and 206 enable the prospective purchaser and the seller to connect, with a view that a vehicle purchase may ensue. Steps 201 through 204 are instrumental in producing the search results used for this purpose. However, in other scenarios, the search results are used for other purposes. For instance, rather than a prospective purchaser searching for available vehicles in a destination market, a dealer can search for available vehicles in a destination market. In this scenario, the dealer may be interested to know profitability of the available vehicles, for example for arbitrage opportunities or other purposes.

In some implementations, the search results include prices that are largely based on the wholesale value. Note that a seller can generate a profit by selling a vehicle in a destination market at wholesale value when the list price plus the cost of exporting the vehicle to the destination market is less than the wholesale value. According to an aspect, the server 110 is able to digitize a process of calculating profits of vehicle sales in the global markets. The digitization of this process is a major step towards globalization of automobile dealership by opening plentiful opportunities and markets across the globe.

In some implementations, the digitization of retail automobile dealerships via websites like Autotrader, Cargurus, Kijiji, etc. along with the online availability of the wholesale prices of the vehicles across markets are the founding blocks of the server 110. In this era of technology driven growth, the basic processes like transportation of a vehicle, import duties applicable for each market, currency exchange rates, eligibility rules for a particular market etc. are all available online. In some implementations, the server 110. fetches the details from all these online sources and uses them to find the best suitable and the most profitable market for a vehicle.

In some implementations, the server 110 sends, over the network, a profitability report indicating profitability of the matching vehicle(s) from step 204. The profitability report can be generated with the foregoing considerations in mind to indicate profitability of the matching vehicle(s) from step 204. This goes beyond connecting prospective buyers and sellers, because it can enable dealers to become more profitable.

In some implementations, the server 110 maintains a global integrated valuation model configured to calculate values for the available vehicles. There are many possibilities. In some implementations, the global integrated valuation model is configured to calculate values for the available vehicles by iterative valuation calculations for any potential permutation of buyer to seller routing across national borders. In some implementations, the global integrated valuation model is configured to calculate values for the available vehicles using a unified valuation model that represents different permutations of modifications of a baseline valuation that may be derived from MSRP (Manufacturer's Suggested Retail Price), current retail or wholesale listings, recent transactions, auction activity, and/or any other observation of price activity in an automotive space. Other implementations are possible.

The processes described herein, and the server 110 for implementing those processes, represent a practical application of networking technology that enables electronic commerce of vehicles across different markets across the globe. This is a new use of networking technology that enables benefits described herein and would not be possible without the use of the networking technology. The new use of networking technology enables multi-market analysis which addresses unique challenges in addressing many markets across the globe. The processes described herein are executed in real-time for many markets across the globe, which would not be possible with networking technology.

There are many possibilities for the server 110. In some implementations, the server 110 includes a web server and data sent by the server 110 includes web content for a web browser. Additionally, or alternatively, the server 110 can include an application server and data sent by the server 110 includes content for a mobile app. Other implementations are possible.

There are many possibilities for the network adapter 112 of the server 110. In some implementations, the network adapter 112 is a single network adapter 112. In other implementations, the network adapter 112 includes multiple network adapters, for example a first network adapter for communicating with the one or more client devices 131-133, and a second network adapter for communicating with other client devices, such as client devices utilized by a system administrator. Both wireless and wired network adapters are possible. Any suitable network adapter that can communicate via the network 140 is possible.

There are many possibilities for the vehicle trade circuitry 114 of the server 110. In some implementations, the vehicle trade circuitry 114 includes a processor 116 that executes software, which can stem from a computer readable medium 118. However, other implementations are possible and are within the scope of this disclosure. Other implementations can include additional or alternative hardware components, such as any appropriately configured FPGA (Field-Programmable Gate Array), ASIC (Application-Specific Integrated Circuit), and/or microcontroller, for example. More generally, the vehicle trade circuitry 114 can be implemented with any suitable combination of hardware, software and/or firmware.

There are many possibilities for the network 140. The network 140 can include several different networks even though such details are not shown for simplicity. For example, the network 140 can include a RAN (Radio Access Network) for communicating with wireless stations and the Internet for communicating with numerous other computing devices. The network 140 would normally include the Internet such that the communication system 100 can span across multiple markets (e.g. multiple countries). The network 140 can have other components as well, but these details are not shown for simplicity.

According to another embodiment of the disclosure, there is provided a non-transitory computer readable medium having recorded thereon statements and instructions that, when executed by the processor 116 of the server 110, implement a method as described herein. The non-transitory computer readable medium can be the computer readable medium 118 of the server 110 shown in FIG. 1, or some other non-transitory computer readable medium. There are many possibilities for non-transitory computer readable medium. Some examples include an SSD (Solid State Drive), a hard disk drive, a CD (Compact Disc), a DVD (Digital Video Disc), a BD (Blu-ray Disc), a memory stick, or any appropriate combination thereof.

### Example Processes

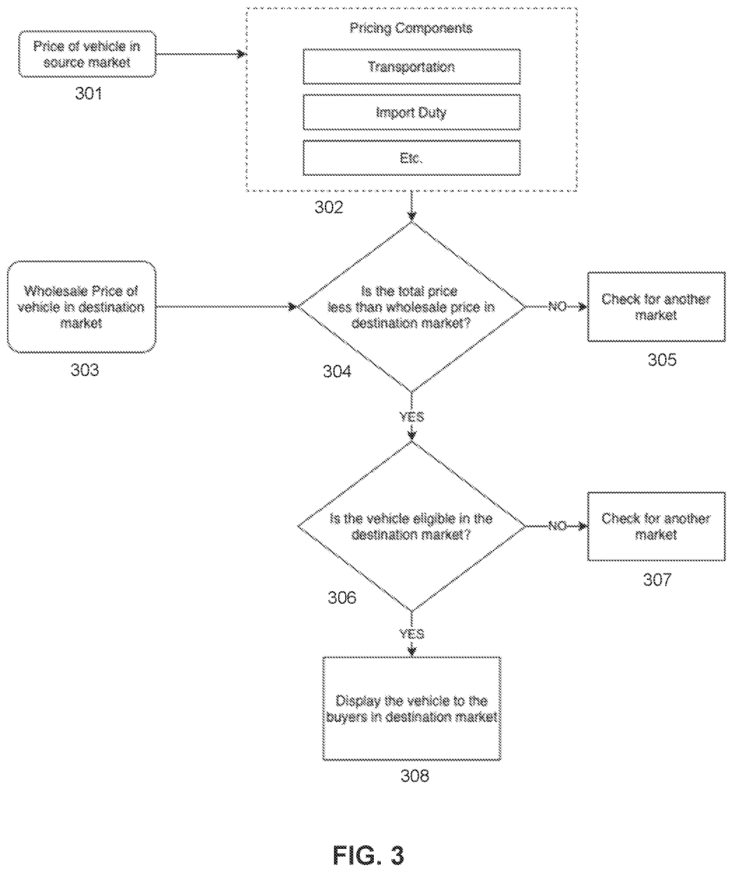

Example processes are described below with reference to FIGS. 3 to 5. These processes can be implemented by a server, for example by the vehicle trade circuitry 114 of the server 110 shown in FIG. 1. More generally, these processes can be implemented by any appropriately configured server of a communications system. It is to be understood that the processes described below with reference to FIGS. 3 to 5 are very specific for exemplary purposes only, such that other processes are possible and within the scope of the disclosure.

By way of overview, the processes can involve the server 110 calculating profitability and check eligibility of new and used vehicles for markets across the globe. The server 110 can fetch wholesale and retail value of a vehicle, identify all applicable charges for exporting the vehicle to a desired market, and can return profitability after performing associated calculations. In some implementations, along with calculating the profitability of a vehicle across globally, the server 110 enables users to find the profitable vehicles from multiple markets across the globe, as per the users' custom requirements.

In some implementations, in order to extend accessibility of a product for global users, the server 110 is integrated with a web Platform, where sellers can directly upload their inventories, and buyers can make purchases for vehicles. In some implementations, the server 110 can help both buyers and sellers by identifying a most profitable destination market for the sellers and by providing most economical vehicles from any market across the globe to the buyers.

Referring first to FIG. 3, shown is a flowchart of a method of offering available vehicles depending on profitability. As described below, available vehicles are offered to prospective buyers only when selling the available vehicles would expect to generate profit.

At step 301, the server 110 receives a retail price of a vehicle in a source market. The retail price can be specified by a seller while uploading their inventories on the platform. Additionally, or alternatively, the retail price can be fetched from retail websites. Owing to the exceptional boom in the technology sector, almost all the markets across the world have retail automobile dealership websites.

At step 302, the server 110 maintains a backend table which contains an exhaustive list of all the pricing components applicable for calculating the cost of exporting the vehicle to a destination market. These components include charges such as transportation, shipment and handling cost, drayage cost, import duty charges, RI/title fee, buyer/seller fee etc.

In some implementations, if a particular pricing component is applicable for the destination market, then the server 110 identifies the charges corresponding to that component. For example, an import duty component depends on a body type and the VIN for the US market. Similarly, transportation charges depend on the body type, source and destination city. In some implementations, all this data is either fetched and fed to the server 110 after a meticulous secondary internet research or from historical deals data.

At step 303, the server 110 receives a wholesale price of the vehicle in the destination market. The wholesale price of the vehicle can be fetched via an API integration with platforms such as Manheim, Adessa, Kelly Black Book etc. These platforms have reliable wholesale values of vehicles, calculated from transactional data collected over several years.

In some implementations, a unique specifier, for example VIN (Vehicle Identification Number), is used to find the correct vehicle and fetch the wholesale price. However, in cases where the VIN is not available, the vehicle can be mapped using a combination of specifications like Year, Make, Model, Trim, etc. The Trim is a version of the Model that comes equipped with a set combination of features. In some implementations, there is provided trim mapping logic to map the Trim of the vehicle with the wholesale database, which can work at an accuracy of 99%.

At step 304, the server 110 determines whether a total price of the vehicle including all export costs is below the wholesale price of the vehicle in the destination market. If the server 110 determines that the total price of the vehicle is not below the wholesale price of the vehicle in the destination market, which mean that it is not practical to sell the vehicle in the destination market, then at step 305 the server 110 checks for another destination market which may provide for a better opportunity for selling the vehicle. In some implementations, step 305 involves repeating steps 302 to 304 for another destination market.

If the server 110 determines that the total price of the vehicle is below the wholesale price of the vehicle in the destination market, which mean that it may be practical to sell the vehicle in the destination market, then at step 306 the server 110 determines whether the vehicle is eligible in the destination market. If the vehicle is not eligible in the destination market, which means that it is not possible to sell the vehicle in the destination market, then at step 307 the server 110 checks for another destination market which may provide for a better opportunity for selling the vehicle.

Note that the vehicle cannot be sold in the destination market if it is not eligible for importing as per rules of that destination market. Eligibility criteria for almost all the markets are available online on government websites. In some implementations, a backend eligibility table for each market specifies applicable criteria. For example, for the United States, eligibility is based on TPMS (Tire Pressure Monitoring System). As another example, for China, eligibility is based on steering wheel position and age of the vehicle.

If the vehicle is eligible in the destination market, then at step 308 the server 110 enables details of the vehicle to be presented to prospective buyers in the destination market. A buy price of the vehicle can be displayed to the prospective buyers in their domestic currency. An API integration with a reliable source such as AFEX (Associated Foreign Exchange) allows the server 110 to convert currencies accurately in real-time. In some implementations, once a prospective buyer decides to make a purchase, the prospective buyer can book the purchase at an ongoing exchange rate and pay later once the vehicle is delivered.

In some implementations, steps 302 to 308 are repeated for multiple destination markets, until all destination markets are identified in which it is practical to sell the vehicle (step 304) and eligible (step 306) as well. This can attract prospective buyers from all over the world, which can benefit the seller of the vehicle.

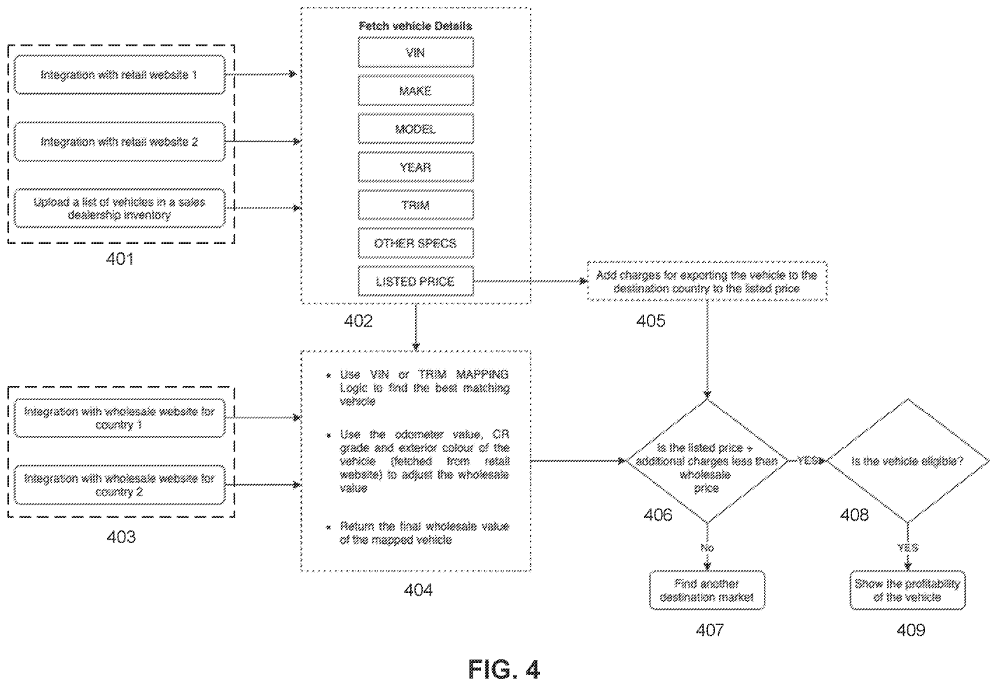

Referring first to FIG. 4, shown is a flowchart of a method of finding profitable vehicles. As described below, profitable vehicles can be found, for example from retail websites, and profitability can be calculated.

At step 401, the server 110 receives vehicle listings. There are many ways that the vehicle listings can be received. In some implementations, the server 110 retrieves the vehicle listings from one or more retail websites. Additionally, or alternatively, the server 110 can access a list of vehicles in a sales dealerships inventory, such as MS Excel inventory sheets shared by the sales dealerships. Such list of vehicles can be uploaded to the server 110 for example.

At step 402, the server 110 stores the vehicle listings that have been obtained. There are many possibilities for the vehicle listings to be stored. For each vehicle, the vehicle listings can for example include VIN, Make, Model, Year, Trim, Other Specs, and Listed Price, for example. The Other Specs can for example include Color, Odometer, Transmission, Drivetrain, etc. Other vehicle listings are possible. Upon completion of steps 401 and 402, the server 110 has detailed records of available vehicles for purchase.

At step 403, the server 110 receives the wholesale prices of the vehicles in multiple markets. The wholesale prices can be fetched via an API integration with platforms such as Manheim, Adessa, Kelly Black Book, etc. These platforms have reliable wholesale values of vehicles, calculated from transactional data collected over several years. Upon completion of step 403, for each available vehicle for purchase identified in steps 401 and 402, the server 110 has wholesale prices of the vehicle in multiple markets.

In some implementations, a unique specifier, for example VIN (Vehicle Identification Number), is used to find the correct vehicle and fetch the wholesale price. However, in cases where the VIN is not available, the vehicle can be mapped using a combination of specifications like Year, Make, Model, Trim, etc. The Trim is a version of the Model that comes equipped with a set combination of features. In some implementations, there is provided trim mapping logic to map the Trim of the vehicle with the wholesale database, which can work at an accuracy of 99%.

At step 404, for each available vehicle, the server 110 adjusts the wholesale prices for the vehicle based on various factors to produce final wholesale prices. The various factors can for example include odometer value, CR (Credit) grade, exterior color of the vehicle, etc. The server 110 returns the final wholesale prices of the vehicle in multiple markets.

As noted above, at step 402 the server 110 has stored the vehicle listings that have been obtained, including the listed price for each available vehicle. At step 405, for each destination market, the server 110 adds charges for exporting the vehicle to the destination market to the listed price. All charges applicable to the vehicle for exporting it to a destination market are added to the listed price.

At step 406, for each available vehicle, and for each destination market, the server 110 determines whether the listed price plus the additional charges for exporting the vehicle to the destination market is less than the wholesale price for the vehicle in the destination market. If the server 110 determines that the listed price plus the additional charges is not below the wholesale price, which mean that it is not practical to sell the vehicle in the destination market, then at step 407 the server 110 checks for another destination market which may provide for a better opportunity for selling the vehicle.

If the server 110 determines that the listed price plus the additional charges is not below the wholesale price, which mean that it may be practical to sell the vehicle in the destination market, then at step 408 the server 110 determines whether the vehicle is eligible in the destination market. If the vehicle is eligible in the destination market, then at step 409, based on the calculations and eligibility criteria, the server 110 generates an output report containing a list of all the profitable vehicles.

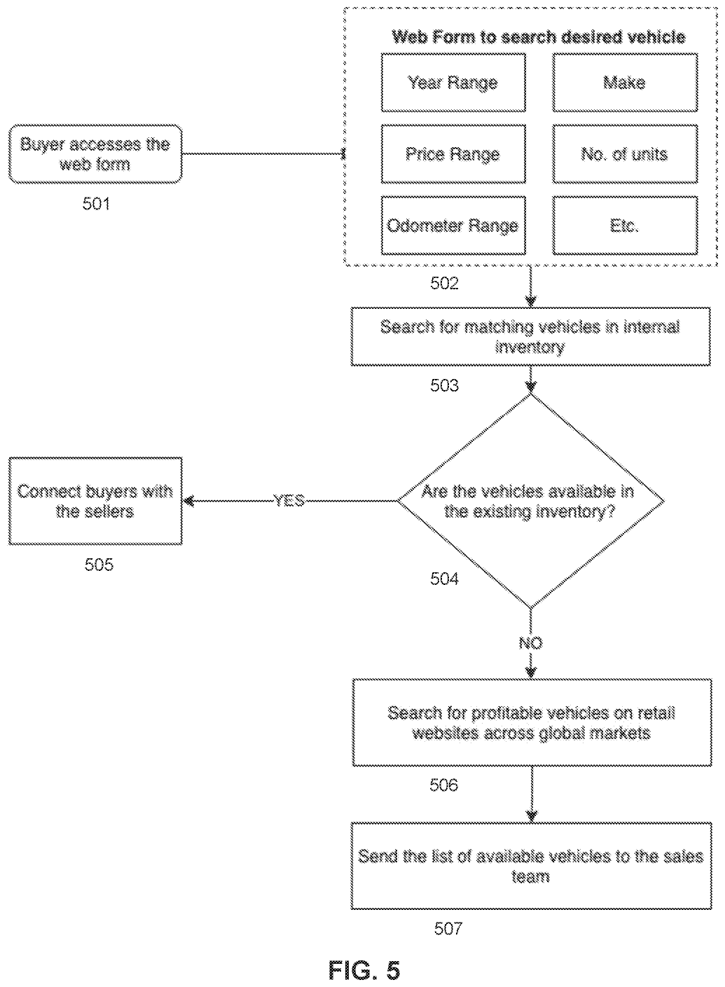

Referring first to FIG. 5, shown is a flowchart of a method of enabling prospective buyers to find their desired vehicles from global markets, with maximum or increased profitability. In addition to connecting buyers and seller digitally, the server 110 helps users to search for their desired vehicles globally. In some implementations, the server 110 not only helps the buyers in searching the desired vehicles but also helps the registered sellers by informing them about the demand for the vehicles in their inventory.

At step 501, the server 110 enables a prospective buyer to access a web form. If a user wants to find vehicles with defined specifications, the user can simply input the specifications in a user-friendly web form and the server 110 can find the profitable vehicles from markets across the globe as described below.

At step 502, the server 110 receives the defined specifications via the web form. The defined specifications can for example include Year Range, Make, Price Range, Number of units, Odometer Range, etc. Other defined specifications are possible.

At step 503, the server 110 searches for matching vehicles in internal inventory. The internal inventory can be populated for example using the processes described above with reference to FIGS. 3 and 4. At step 504, the server 110 determines whether there are any available vehicles in the existing inventory that match the defined specifications.

If there are available vehicles in the existing inventory that match the defined specifications, then at step 505 the server 110 displays details of the available vehicles. In addition, the server 110 connects the prospective buyer with the sellers. This can enable communication between the prospective buyer and the sellers while the prospective buyer decides whether to make a purchase.

In some implementations, if there are no available vehicles in the existing inventory that match the defined specifications, then at step 506 the server 110 searches for profitable vehicles on retail websites across global markets, and at step 507 provides a list of available vehicles to a sales team, with a view that the sales team can review and update the internal inventory accordingly.

Based on the foregoing processes, there are a number of usages for the server 110. A non-exhaustive list of usages is provided below. Note that these example usages are very specific and that other usages are possible.

1. To connect the global users (buyers and sellers) from different markets and provide maximum or increased profitability on their inventory.
2. To generate a report of profitable vehicles across the retail websites of a market in order in expand the internal inventory with vehicles which can provide maximum or increased profit in overseas markets.
3. To check the number of profitable vehicles from an inventory list shared by a registered sales dealership.
4. To allow the buyers to input their desired vehicle specifications and map it with the available vehicles across the global markets. To help the sellers connect with the buyers based on the requirements uploaded by the buyers.

Numerous modifications and variations of the present disclosure are possible in light of the above teachings. It is therefore to be understood that within the scope of the appended claims, the disclosure may be practised otherwise than as specifically described herein.

We claim:

1. A method for execution by a server of a communications system having a network, the method comprising:
receiving, over the network, vehicle listings concerning available vehicles for purchase across global markets, wherein the vehicle listings comprise, for each available vehicle, identifying information of the available vehicle and a list price of the available vehicle in a source market;
receiving, over the network, for each available vehicle and for each market of a plurality of markets, a wholesale value of the available vehicle in the market;
receiving, over the network, a message having search parameters for a available vehicles in a destination market; and
sending, over the network, search results comprising the identifying information of one or more matching vehicles of the available vehicles, wherein the available vehicles are conditionally included in the search results based on whether the available vehicles match the search parameters and each additional condition of a set of at least one additional condition is met;
wherein the set of at least one additional condition comprises, for each available vehicle in which the source market is different from the destination market, the list price plus additional charges for exporting the available vehicle from the source market to the destination market being less than the wholesale value in the destination market; and
wherein for at least one of the matching vehicle(s), the source market of the matching vehicle is different from the destination market.

2. The method of claim 1, comprising:
monitoring of costs or fees, taxes, foreign exchange rates and/or cost of capital;
based on the monitoring, determining a difference between (i) the list price plus the additional charges for exporting the available vehicle from the source market to the destination market and (ii) the wholesale value in the destination market.

3. The method of claim 1, wherein the set of at least one additional condition further comprises, for each available vehicle, the available vehicle being eligible for sale in the destination market according to law and/or regulation.

4. The method of claim 3, comprising:
monitoring admissibility and logistics regulation; and
determining the law and/or regulation via the monitoring.

5. The method of claim 1, further comprising:
maintaining a database of the available vehicles; and
generating the search results based on an internal search of the database using the search parameters.

6. The method of claim 5, wherein generating the search results is further based on an external search of available vehicles for purchase across global markets.

7. The method of claim 1, further comprising:
receiving, over the network, a message identifying a selected vehicle for possible purchase among the matching vehicle(s); and
connecting a prospective buyer with a seller of the selected vehicle.

8. The method of claim 1, further comprising:
sending, over the network, a profitability report indicating profitability of the matching vehicle(s).

9. The method of claim 1, comprising:
maintaining a global integrated valuation model configured to calculate values for the available vehicles.

10. The method of claim 9, wherein the global integrated valuation model is configured to calculate values for the available vehicles by iterative valuation calculations for any potential permutation of buyer to seller routing across national borders.

11. The method of claim 9, wherein the global integrated valuation model is configured to calculate values for the available vehicles using a unified valuation model that represents different permutations of modifications of a baseline valuation that may be derived from MSRP (Manufacturer's Suggested Retail Price), current retail or wholesale listings, recent transactions, auction activity, and/or any other observation of price activity in an automotive space.

12. The method of claim 1, wherein the message having the search parameters is received via a web form.

13. The method of claim 1, comprising:
integrating with retail websites, wherein at least some of the vehicle listings concerning available vehicles are received via the retail websites.

14. The method of claim 1, comprising:
receiving a list of vehicles in a sales dealership inventory, wherein at least some of the vehicle listings concerning available vehicles are received via the list of vehicles in the sales dealership inventory.

15. The method of claim 1, comprising:
monitoring of inventory in market, via API (Application Programming Interface) feeds, content aggregators, and/or web indexing;
wherein at least some of the vehicle listings concerning available vehicles are received via the monitoring.

16. The method of claim 1, comprising:
integrating with wholesale websites, wherein at least some of the wholesale values are received via the wholesale websites.

17. The method of claim 1, comprising:
classifying and/or grouping of individual inventory items across global market for aspects of similarity to obtain the wholesale values using:
a VIN (Vehicle Identification Number) number, or details derived thereof;
logic or rule-based processing; and/or
clustering, classification, regression, or other mathematical methods that are trained from any type of data.

18. A non-transitory computer readable medium having recorded thereon statements and instructions that, when executed by a processor of a server, configure the processor to implement a method according to claim 1.

19. A server, comprising:
a network adapter;
vehicle trade circuitry coupled to the network adapter and configured to implement a method according to claim 1.

20. The server of claim 19, wherein:
the vehicle trade circuitry comprises a processor; and
the server further comprises a non-transitory computer readable medium having recorded thereon statements and instructions that, when executed by the processor, configures the processor as the vehicle trade circuitry.

21. The server of claim 20, wherein the non-transitory computer readable medium further comprises a database of the available vehicles.

22. A method for execution by a server of a communications system having a network, the method comprising:
receiving, over the network, a vehicle listing concerning an available vehicle, wherein the vehicle listing comprises identifying information for the available vehicle and a list price for the available vehicle in a source market;
receiving, over the network, a wholesale value for the available vehicle in a destination market, wherein the destination market and the source market are different markets;
receiving, over the network, a message concerning potential purchase of the available vehicle in the destination market;
sending, over the network, the identifying information for the available vehicle only if each condition of a set of at least one condition is met;
wherein the set of at least one condition comprises the list price plus additional charges for exporting the available vehicle from the source market to the destination market being less than the wholesale value in the destination market.

23. The method of claim 22, wherein the set of at least one condition further comprises the available vehicle being eligible for sale in the destination market according to law and/or regulation.

24. The method of claim 22, wherein the message concerning potential purchase of the available vehicle comprises a message having search parameters for available vehicles in the destination market.

25. A non-transitory computer readable medium having recorded thereon statements and instructions that, when executed by a processor of a server, configure the processor to implement a method according to claim 22.

26. A server, comprising:
a network adapter;
vehicle trade circuitry coupled to the network adapter and configured to implement a method according to claim 22.

27. The server of claim 26, wherein:
the vehicle trade circuitry comprises a processor; and
the server further comprises a non-transitory computer readable medium having recorded thereon statements and instructions that, when executed by the processor, configures the processor as the vehicle trade circuitry.

28. A method for execution by a server of a communications system having a network, the method comprising:
receiving, over the network, vehicle listings concerning available vehicles for purchase across global markets, wherein the vehicle listings comprise, for each available vehicle, identifying information of the available vehicle in a source market;
receiving, over the network, for each available vehicle and for each market of a plurality of markets, a wholesale value of the available vehicle in the market;
receiving, over the network, a message having search parameters for available vehicles in a destination market; and
sending, over the network, search results comprising the identifying information of one or more matching vehicles of the available vehicles, wherein the available vehicles are conditionally included in the search results based on whether the available vehicles match the search parameters and each additional condition of a set of at least one additional condition is met;
wherein the set of at least one additional condition comprises, for each available vehicle, the available vehicle being eligible for sale in the destination market according to law and/or regulation; and
wherein for at least one of the matching vehicle(s), the source market of the matching vehicle is different from the destination market.
